(19) United States
(12) Patent Application Publication
(10) Pub. No.: US 2017/0162037 A1
(43) Pub. Date: Jun. 8, 2017

(54) OPERATOR CONTROL APPARATUS, ELECTRONIC DOMESTIC APPLIANCE, MOBILE OPERATOR CONTROL UNIT AND SYSTEM

(71) Applicant: DIEHL AKO STIFTUNG & CO. KG, Wangen (DE)

(72) Inventors: ANDREAS MAIGLER, BAD WALDSEE (DE); THOMAS FROMMELT, MUENCHEN (DE); JOACHIM LYSZUS, BAINDT (DE); RALPH STOHR, LEUTKIRCH (DE); BRUNO FUHGE, ACHBERG (DE)

(21) Appl. No.: 15/433,153

(22) Filed: Feb. 15, 2017

Related U.S. Application Data
(63) Continuation of application No. PCT/EP2015/001616, filed on Aug. 5, 2015.

(30) Foreign Application Priority Data
Aug. 22, 2014 (DE) 10 2014 012 629.3

(51) Int. Cl. G08C 17/02; H04M 1/725; G06F 3/01

(52) U.S. Cl. CPC G08C 17/02; G06F 3/017; H04M 1/72533; G08C 2201/32; G08C 2201/93; G08C 2201/91

(57) ABSTRACT

An operator control apparatus for an electronic device, in particular an electronic domestic appliance, includes an operator control unit detection device for detecting a mobile operator control unit in the vicinity of the operator control apparatus. The detection device has a communication interface for a radio connection with the mobile operator control unit, and a gesture detection device for detecting gestures performed by the mobile operator control unit. A control device of the operator control apparatus, which is connected to the detection device and the gesture detection device, controls the electronic device as a function of the gestures of the mobile operator control unit detected by the gesture detection device, after the mobile operator control unit has been detected in the vicinity of the operator control apparatus by the detection device. An electronic domestic appliance, a mobile operator control unit and a system are also provided.

### CROSS-REFERENCE TO RELATED APPLICATION

This is a continuation application, under 35 U.S.C. §120, of copending International Application PCT/EP2015/001616, filed Aug. 5, 2015, which designated the United States; this application also claims the priority, under 35 U.S.C. §119, of German Patent Application DE 10 2014 012 629.3, filed Aug. 22, 2014; the prior applications are herewith incorporated by reference in their entirety.

### BACKGROUND OF THE INVENTION

### Field of the Invention

The present invention relates to an operator control apparatus for an electronic device, in particular for an electronic domestic appliance, an electronic domestic appliance including such an operator control apparatus, a mobile operator control unit for non-contact operator control of an electronic device, in particular of an electronic domestic appliance, and a system including such an operator control apparatus or such an electronic device and such a mobile operator control unit.

It is, for example, known from German Utility Model DE 20 2009 003 894 U1 or German Patent Application DE 10 2013 009 168 A1 to control electronic domestic appliances by using gestures of a hand of a user, which are detected and identified by a corresponding gesture detection device of the operator control apparatus of the domestic appliance. For that purpose, the gesture detection devices typically include optical sensors or cameras.

### SUMMARY OF THE INVENTION

It is accordingly an object of the invention to provide an operator control apparatus, an electronic domestic appliance, a mobile operator control unit and a system, which overcome the hereinafore-mentioned disadvantages of the heretofore-known devices of this general type and which enable a convenient and reliable operator control of an electronic device by using gestures.

With the foregoing and other objects in view there is provided, in accordance with the invention, an operator control apparatus for an electronic device, including an operator control unit detection device for detecting a mobile operator control unit in the vicinity of the operator control apparatus. The operator control unit detection device has a communication interface for a radio connection with the mobile operator control unit. A gesture detection device is provided for detecting gestures performed by the mobile operator control unit. The operator control apparatus according to the present invention furthermore includes a control device which is connected to the operator control unit detection device and the gesture detection device, for controlling the electronic device as a function of the gestures of the mobile operator control unit detected by the gesture detection device, after the mobile operator control unit has been detected in the vicinity of the operator control apparatus by the operator control unit detection device.

Through the use of this operator control apparatus, the option exists, in a first step, to establish a one-to-one connection or coupling between the operator control apparatus and a correspondingly equipped mobile operator control unit (so-called “pairing”) through a radio connection, and then to carry out the operator control of the electronic device in a non-contact manner by using gestures. Due to the one-to-one connection between the operator control apparatus and the mobile operator control unit, the gesture control of the electronic device may subsequently take place securely and reliably.

Due to the use of the mobile operator control unit both for the pairing operation and for the gesture control, the user may, for example, keep the mobile operator control unit in the hand during the entire operator control operation. Therefore, the operator control of the device is more fluid for the user and thus more convenient. In addition, it provides the user with additional functions of its mobile operator control unit in connection with the operator control of domestic appliances or other controllable devices.

The present invention is, in particular, suitable for use with electronic domestic appliances, for example, cooktops, exhaust hoods, stoves, dishwashers, laundry treatment appliances, and the like, without the present invention being limited to these applications.

In this context, the mobile operator control unit, the presence of which in the vicinity of the operator control apparatus and the gestures of which are to be detected, is generally any object which is able to communicate by radio. This characteristic for radio communication may already be present in the object in any case, or may be imparted to the object through an additional radio module or the like. In this context, particularly suitable mobile operator control units include multimedia devices (smartphones, tablet PCs, etc.), wristbands, watches, styluses, and the like, without the present invention being limited to the aforementioned device types.

In this context, the term “gestures” is to denote any type of motion or combination of motions. Simple gestures, for example, include (horizontal) sweeping motions and (vertical) up and down motions. More complex gestures include, for example, circular motions, rotating motions, tilting motions, and the like.

Any radio technology may generally be used for the radio connection. Preferably, known radio-controlled systems based on WLAN (wireless local area network), NFC (near field communication), or RFID (radio frequency identification) are used for the radio connection between the operator control apparatus and the mobile operator control unit.

In one preferred embodiment of the present invention, the gesture detection device is configured to detect gestures of the mobile operator control unit in the vicinity of the operator control apparatus. For this purpose, known gesture detection devices, for example, including optical sensors or camera systems, may preferably be used. In this embodiment, the gesture detection generally takes place independently of, and subsequent to, the pairing operation in which the mobile operator control unit is detected.

In an additional preferred embodiment of the present invention, the gesture detection device has a communication interface for a radio connection with the mobile operator control unit. The communication interface of the gesture detection device may preferably be the communication interface of the operator control unit detection device or a separate communication interface. If the mobile operator control unit is itself able to detect the gestures performed by the operator control unit, the detected gestures may then be communicated to the gesture detection device of the operator control apparatus through this radio connection.

In yet another embodiment of the present invention, the gesture detection device is configured to detect gestures of the mobile operator control unit from a characteristic of the detection of the mobile operator control unit, through the operator control unit detection device. This characteristic of the detection of the mobile operator control unit is, for example, a number, a speed, etc. of pairing operations.

In yet another embodiment of the present invention, the operator control apparatus includes at least two operator control unit detection devices for detecting a mobile operator control unit in the vicinity of the operator control apparatus, and the gesture detection device is configured to detect gestures of the mobile operator control unit from a combination of the detections of the mobile operator control unit, through the operator control unit detection device. This combination of the detections of the mobile operator control unit is, for example, a sequence of the pairing operations with the different operator control unit detection devices.

With the objects of the invention in view, there is also provided an electronic domestic appliance including at least one operator control apparatus of the present invention described above.

With the objects of the invention in view, there is furthermore provided a mobile operator control unit for non-contact operator control of an electronic device of the present invention, including a radio transmitter having a communication interface for a radio connection with an operator control apparatus of the electronic device, which is provided in order to be able to detect the mobile operator control unit in the vicinity of the operator control apparatus.

Through the use of this mobile operator control unit, the same advantages may be achieved as with the operator control apparatus described above and therefore, it is not necessary to repeat the description of the same here.

The radio transmitter of the mobile operator control unit is optionally an active radio transmitter or a passive radio transmitter. In this context, the terms “active” and “passive” are also to apply to the conventional terminology used in connection with RFID technology.

In one preferred embodiment of the present invention, the mobile operator control unit furthermore includes a gesture identification device for identifying gestures performed by the mobile operator control unit, wherein the gesture identification device has a communication interface for a radio connection with the operator control apparatus of the electronic device, in order to be able to communicate the identified gestures to the operator control apparatus. In this case, the gesture identification device may use the communication interface of the radio transmitter or may be provided with its own communication interface.

In an additional preferred embodiment of the present invention, the mobile operator control unit also includes a storage device which is connected to the radio transmitter for storing personalized user data. In this embodiment, the option exists to transmit user-specific data (for example, default settings of the device, preferred settings, authorization levels, etc.) along with or after the pairing operation between the operator control apparatus and the mobile operator control unit of the operator control apparatus.

In yet another preferred embodiment of the present invention, the mobile operator control unit is constructed as a multimedia device, for example, a smartphone, a tablet PC, an intelligent watch, etc. Such multimedia devices often include radio modules in any case, which are suitable for a radio connection with the operator control apparatus.

With the objects of the invention in view, there is additionally provided a system including at least one operator control apparatus of the present invention described above, and at least one mobile operator control unit of the present invention described above.

With the objects of the invention in view, there is concomitantly provided a system including at least one electronic device, in particular an electronic domestic appliance, of the present invention, and at least one mobile operator control unit of the present invention described above.

Other features which are considered as characteristic for the invention are set forth in the appended claims.

Although the invention is illustrated and described herein as embodied in an operator control apparatus, an electronic domestic appliance, a mobile operator control unit and a system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified block diagram of a system made up of an operator control apparatus and a mobile operator control unit, according to a first exemplary embodiment of the present invention;

FIG. 2 is a simplified block diagram of a system made up of an operator control apparatus and a mobile operator control unit, according to a second exemplary embodiment of the present invention; and

FIG. 3 is a simplified block diagram of a system made up of an operator control apparatus and a mobile operator control unit, according to a third exemplary embodiment of the present invention.

### DETAILED DESCRIPTION OF THE INVENTION

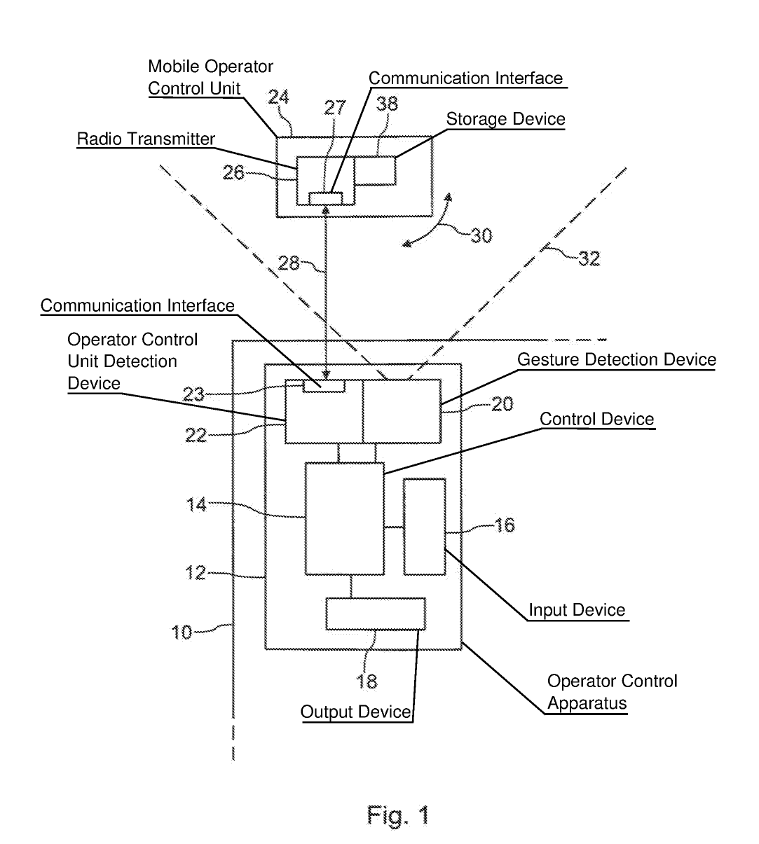

Referring now in detail to the figures of the drawings which show preferred, non-restrictive, exemplary embodiments of the invention and first, particularly, to FIG. 1 thereof, there is seen an electronic domestic appliance 10, for example a cooktop, which includes a specific operator control apparatus 12.

The operator control apparatus 12 includes a control device 14 for controlling the domestic appliance 10 or its assemblies. The control device 14 includes, for example, a microcontroller. This control device 14 is connected to an input device 16 which, for example, is constructed as a conventional input device having touch-sensitive and/or proximity-sensitive pushbutton switches (so-called touch control). In addition, the control device 14 is connected to an output device 18 which, for example, includes various display devices (displays, light-emitting diodes, etc.) for displaying operating states, set parameter values, etc. and/or various acoustic devices for outputting warning or indication signals.

Furthermore, the control device 14 is connected to a gesture detection device 20. In this exemplary embodiment, the gesture detection device 20 is configured to detect and to identify gestures 30 within a gesture monitoring space 32, which a user performs in the vicinity of the operator control apparatus 12 through a mobile operator control unit or terminal 24. The gestures 30 which may be detected and identified in this way include, for example, simple (horizontal) sweeping motions, simple (vertical) up and down motions, more complex circular, rotating, and/or tilting motions, and the like. For this purpose, the gesture detection device 20 includes, for example, optical sensors and/or a camera system.

In order to differentiate gestures 30, for example, the distance between the gesture detection device 20 and a location in the gesture monitoring space 32 at which the gestures 30 are performed, may also be used. An additional or alternative option for differentiating gestures 30 may, for example, be the type of approach, for example, their speed, the direction from which gestures 30 approach the gesture detection device 20, or a number of repetitions of gestures 30.

The operator control apparatus 12 furthermore includes an operator control unit detection device 22 having a communication interface 23 through which it may communicate by radio with a mobile operator control unit 24, more precisely, with a communication interface 27 of a radio transmitter 26 of a mobile operator control unit, over a radio connection 28.

The operator control of the domestic appliance 10 by a user takes place with the aid of an aforementioned mobile operator control unit 24. The mobile operator control unit 24 is, for example, a multimedia device, for example, a smartphone, a tablet PC, an intelligent watch, or the like. Alternatively, the mobile operator control unit may be constructed as a kind of wristband, a stylus, eyeglasses, or the like.

The mobile operator control unit 24 includes an (active or passive) radio transmitter 26 having a communication interface 27. Thus, the radio transmitter 26 of the mobile operator control unit 24 may communicate with the operator control unit detection device 22 of the operator control apparatus 12 by over radio connection 28.

Optionally, the mobile operator control unit 24 also includes a storage device 38 in which personalized user data may be stored. These personalized user data, for example, include preferred parameter values of a user, preset menu selections of a user, blocking or enabling flags for a user, and the like. In this regard, for example, different mobile operator control units may be assigned to different users, or user data for different users may be stored and selected in a mobile operator control unit.

The functionality of the system depicted in FIG. 1, which is made up of an operator control apparatus 12 and a mobile operator control unit 24, will now be described in greater detail.

Before the user is able to make settings, etc. on the operator control apparatus 12 by using gestures 30, a so-called pairing operation must be carried out in order to establish a one-to-one connection or coupling between the operator control apparatus 12 and the mobile operator control unit 24. For this purpose, the user moves the mobile operator control unit 24 into the vicinity of the operator control apparatus 12, so that the operator control unit detection device 22 of the operator control apparatus 12 is able to receive an identification signal by radio 28 from the radio transmitter 26 (in the case of an active radio transmitter). If the mobile operator control unit 24 includes a passive radio transmitter (for example, a passive RFID tag), the radio transmitter 26 must initially receive an activation signal from the operator control unit detection device 22 in order to then transmit back its identification signal to the operator control unit detection device 22.

A successfully completed pairing operation may be communicated to the user, for example, by outputting a signal tone or a blinking LED through the output device 18.

If such a pairing operation is completed, the control device 14 of the operator control apparatus 12 activates the gesture detection device 20. The activated gesture detection device 20 may then detect and identify gestures 30 carried out by the mobile operator control unit 24 in the predefined gesture monitoring space 32. Preferably, the gesture detection device 20 is activated by the control device 14 only for a predetermined period of time. If the gesture detection device 20 detects a gesture 30 in the predefined time window after the pairing operation, the activation period may possibly be extended. Otherwise, the gesture detection device 20 is again deactivated and would have to be reactivated through another pairing operation by the operator control unit detection device 22.

After the identification of gestures 30 by the gesture detection device 20, the control device 14 may control the domestic appliance 10 or its assemblies as a function of the identified gestures 30. This control may, for example, include the activation and deactivation of assemblies (for example, heating zones, pumps, drive motors, etc.), the modification of parameter values (for example, cooking levels, spinning speeds, etc.), the selection of program menus, and the like. In this case, the gesture detection device 20 may preferably also identify multiple gestures 30 in succession.

The settings carried out through the gestures 30 are displayed to the user, preferably through the output device 18.

Alternatively or in addition, the user may also use the input device 16 of the operator control apparatus 12, for example, to make additional settings on the operator control apparatus 12. Through the use of the input device 16, it is also possible for the user to operate the operator control apparatus 12 even without a corresponding mobile operator control unit 24, if necessary.

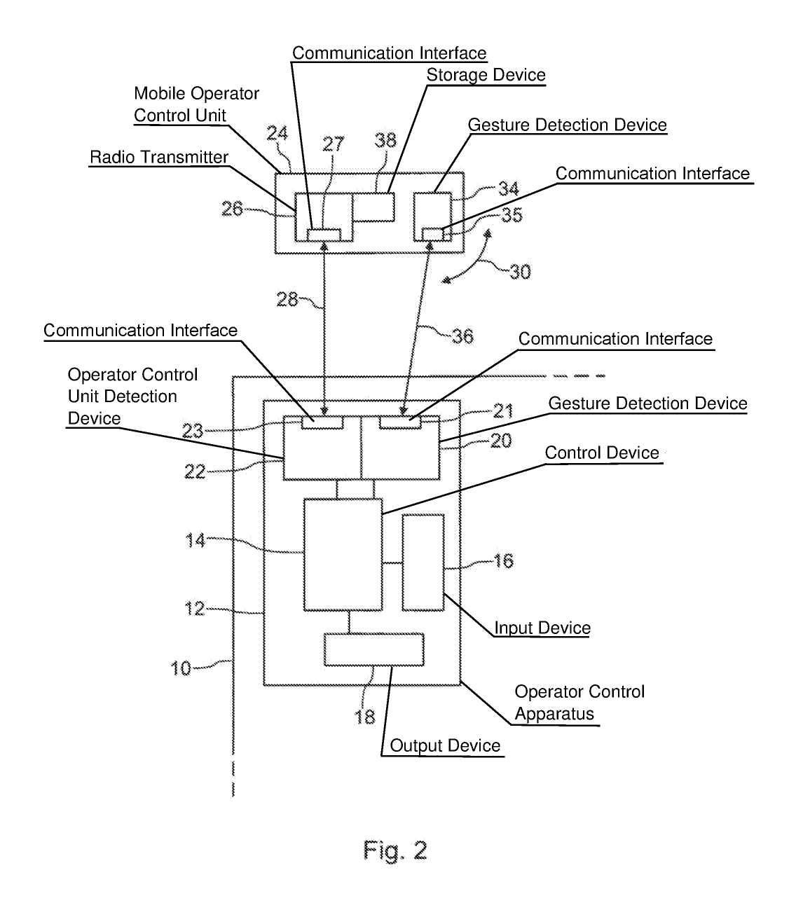

A second exemplary embodiment will now be explained in greater detail, with reference to FIG. 2. In this case, identical or corresponding components are indicated by the same reference numerals as in the first exemplary embodiment described above.

The system according to the second exemplary embodiment depicted in FIG. 2 differs from the first exemplary embodiment according to FIG. 1 in particular due to the type of gesture detection and identification.

For example, the gesture detection device 20 has a communication interface 21 for receiving data relating to gestures 30 from the mobile operator control unit 24 over a radio connection 36. On the other hand, the gesture detection device 20 is not itself able to detect gestures 30 performed by the mobile operator control unit 24. The gestures 30 are instead detected and identified by a gesture identification device 34 provided in the mobile operator control unit 24. For this purpose, the gesture identification device 34 includes, for example, one or multiple position or acceleration sensors, preferably for different spatial directions, and a communication interface 35 for the radio connection 36 with the gesture detection device 20 of the operator control apparatus 12.

Optionally, the operator control apparatus 12 may also be modified in such a way that the operator control unit detection device 22 and the gesture detection device 20 have a shared communication interface for a radio connection with the mobile operator control unit 24. In a similar way, the mobile operator control unit 24 may optionally also be modified in such a way that the radio transmitter 26 and the gesture identification device 34 have a shared communication interface for a radio connection with the operator control apparatus 12.

In addition, the operator control unit detection device 22 and the gesture detection device 20 of the operator control apparatus 12 may optionally also be integrated into a single component.

Otherwise, the operator control apparatus 12 and the mobile operator control unit 24 of this second exemplary embodiment correspond to the system of the first exemplary embodiment of FIG. 1.

With respect to the functionality of the system of FIG. 2, after a successful pairing operation between the operator control unit detection device 22 of the operator control apparatus 12 and the radio transmitter 26 of the mobile operator control unit 24 (as described in greater detail above in connection with the first exemplary embodiment), the gesture detection and identification is carried out by the gesture identification device 34 of the mobile operator control unit 24. The gesture identification device 34 then automatically transmits corresponding data signals through the radio connection 36 to the gesture detection device 20 of the operator control apparatus 12, which relays them to the control device 14. For this purpose, the mobile operator control unit 24 should preferably remain in the near field of the operator control apparatus 12 in which the pairing operation has also taken place.

Otherwise, the functionality of this second exemplary embodiment corresponds to that of the system of the first exemplary embodiment of FIG. 1.

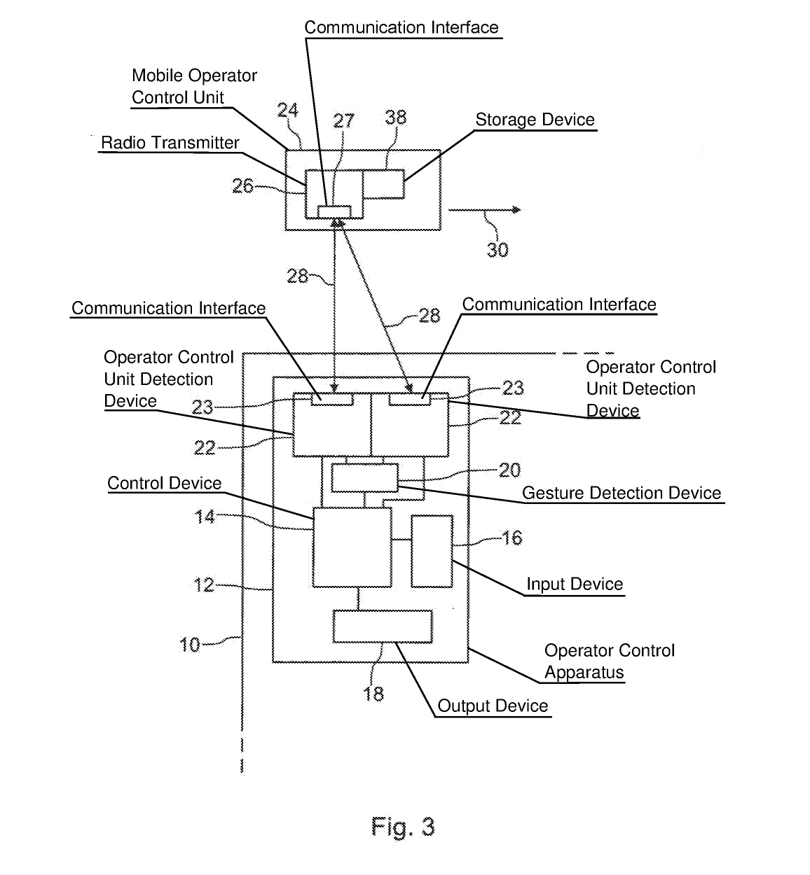

A third exemplary embodiment will now be described with reference to FIG. 3. In this case, identical or corresponding components are indicated by the same reference numerals as in the first exemplary embodiment described above.

The system according to the third exemplary embodiment depicted in FIG. 3 also differs from the first exemplary embodiment according to FIG. 1 in particular due to the type of gesture detection and identification.

Thus, the operator control apparatus 12 in this exemplary embodiment includes at least two operator control unit detection devices 22, each being provided with a communication interface 23 for a radio connection 28 with the radio transmitter 26 of the mobile operator control unit 24. The at least two operator control unit detection devices 22 are preferably positioned to be spaced apart from each other at the operator control apparatus 12 of the domestic appliance 10.

The gesture detection device 20 of the operator control apparatus 12 is connected to all of the operator control unit detection devices 22. In addition, it is configured to evaluate a characteristic of the pairing operations between the mobile operator control unit 24 and the various operator control unit detection devices 22 of the operator control apparatus 12, and to identify gestures 30 of the operator control units 24 therefrom.

Otherwise, the operator control apparatus 12 and the mobile operator control unit 24 of this third exemplary embodiment correspond to the system of the first exemplary embodiment of FIG. 1.

With respect to the functionality of the system of FIG. 3, depending on the number of operator control unit detection devices 22 present, multiple pairing operations between the operator control apparatus 12 and the mobile operator control unit 24 may take place (as described in detail above in connection with the first exemplary embodiment). From the sequence of these pairing operations, the gesture detection device 20 identifies a direction of motion of the mobile operator control unit 24 relative to the operator control apparatus 12 and evaluates this as gestures 30.

Otherwise, the functionality of this third exemplary embodiment corresponds to that of the system of the first exemplary embodiment of FIG. 1.

In a modification (not depicted) of the third exemplary embodiment, the operator control apparatus 12 includes only (exactly) one operator control unit detection device 22 having a communication interface 23. In this case, the gesture detection device 20 of the operator control apparatus 12 is configured to evaluate a characteristic of the pairing operation between the mobile operator control unit 24 and the one operator control unit detection unit 22 of the operator control apparatus 12, and to identify gestures 30 of the mobile operator control unit 24 therefrom.

Thus, for example, the user may repeatedly bring the mobile operator control unit 24 into the vicinity of the operator control apparatus 12 and remove it again. On one hand, this corresponds to multiple pairing operations. On the other hand, for example, the number of pairing operations, the speed of one or multiple pairing operations, the time gaps between pairing operations, etc. may be evaluated as gestures 30 by the gesture detection device 20.

Of course, other exemplary embodiments of the operator control apparatus 12, the mobile operator control unit 24, and the system made up of an operator control apparatus 12 and a mobile operator control unit 24, are conceivable within the scope of protection defined by the appended claims. These result, for example, through single or multiple combinations of the above exemplary embodiments and their modification options.

1. An operator control apparatus for an electronic device or an electronic domestic appliance, the operator control apparatus comprising:
an operator control unit detection device for detecting a mobile operator control unit in a vicinity of the operator control apparatus, said operator control unit detection device having a communication interface for a radio connection with the mobile operator control unit;
a gesture detection device for detecting gestures performed by the mobile operator control unit; and
a control device connected to said operator control unit detection device and to said gesture detection device for controlling the electronic device as a function of the gestures of the mobile operator control unit detected by said gesture detection device, after the mobile operator control unit has been detected in the vicinity of the operator control apparatus by the operator control unit detection device.

2. The operator control apparatus according to claim 1, wherein said gesture detection device is configured to detect gestures of the mobile operator control unit in the vicinity of the operator control apparatus.

3. The operator control apparatus according to claim 1, wherein said gesture detection device has a communication interface for a radio connection with the mobile operator control unit.

4. The operator control apparatus according to claim 1, wherein said gesture detection device is configured to detect gestures of the mobile operator control unit from a characteristic of the detection of the mobile operator control unit, through said operator control unit detection device.

5. The operator control apparatus according to claim 1, wherein:
said operator control unit detection device is one of at least two operator control unit detection devices for detecting a mobile operator control unit in the vicinity of the operator control apparatus; and
said gesture detection device is configured to detect gestures of the mobile operator control unit from a combination of the detections of the mobile operator control unit, through said operator control unit detection device.

6. An electronic domestic appliance, comprising at least one operator control apparatus according to claim 1.

7. A mobile operator control unit for non-contact operator control of an electronic device or an electronic domestic appliance, the mobile operator control unit comprising:
a radio transmitter having a communication interface for providing a radio connection with an operator control apparatus of the electronic device to detect the mobile operator control unit in a vicinity of the operator control apparatus.

8. The mobile operator control unit according to claim 7, which further comprises a gesture identification device for identifying gestures performed by the mobile operator control unit, said gesture identification device having a communication interface for providing a radio connection with the operator control apparatus of the electronic device to communicate the identified gestures to the operator control apparatus.

9. The mobile operator control unit according to claim 7, which further comprises a storage device connected to said radio transmitter for storing personalized user data.

10. The mobile operator control unit according to claim 7, wherein the mobile operator control unit is a multimedia device.

11. A system, comprising:
at least one operator control apparatus according to claim 1; and
at least one mobile operator control unit according to claim 7.

12. A system, comprising:
at least one electronic device or electronic domestic appliance according to claim 6; and
at least one mobile operator control unit according to claim 7.
